(19) United States
(12) Patent Application Publication
(10) Pub. No.: US 2026/0002578 A1
(43) Pub. Date: Jan. 1, 2026

(54) CHAIN LINK AND METHOD FOR PRODUCING A CHAIN LINK

(71) Applicant: THIELE GMBH & CO. KG, Iserlohn (DE)

(72) Inventors: Andreas PANKOEKER, Dortmund (DE); Rene VOELZ, Dortmund (DE)

(21) Appl. No.: 19/114,460

(22) PCT Filed: Sep. 7, 2023
(86) PCT No.: PCT/DE2023/100665

§ 371 Date: Mar. 24, 2025

(30) Foreign Application Priority Data
Sep. 27, 2022 (DE) 10 2022 124 870.4

(51) Int. Cl. F16G 13/12

(52) U.S. Cl. CPC F16G 13/12

(57) ABSTRACT

A chain link for a link chain has two legs running parallel to one another, and connected to one another at the ends via curves. The legs and curves are circular in cross-sections. The legs have smaller cross-sectional areas compared to the cross-sectional areas of the curves. The chain link is manufactured by radial forging with: providing a profile bar, and the profile bar is made of a steel material, inserting the profile bar into a radial forging machine and radial forging with reduction of the diameter of the profile bar in longitudinal portions, so that the profile bar is axially stretched in the forged longitudinal portion, wherein the diameter is reduced at least in the region of the later legs, and removing the radially forged chain link semi-finished product and forming the profile bar into a chain link as well as welding the front ends of the formed chain link.

### RELATED APPLICATIONS

The present application is a National Phase of International Application Number PCT/DE2023/100665, filed Sep. 7, 2023, and claims priority of German Application Number 10 2022 124 870.4 filed Sep. 27, 2022.

### FIELD

The present disclosure relates to a chain link for a link chain.

The present disclosure further relates to a method for producing a chain link for a link chain.

### BACKGROUND

The link chains in question are used primarily in mining, such as in underground mining. Underground mining requires a high level of strength to transfer kinetic energy to mining equipment, such as planer chains or conveyor chains. In such chain drives, the chains run via sprockets, such as in an upper run and a lower run.

The link chain includes horizontal links, which run horizontally when installed, and vertical links, which are arranged in a vertically oriented manner when installed. The horizontal and vertical links are each designed as a circumferential chain link. For this purpose, the links each have two parallel legs. The legs are connected at respective ends by a respective curve. In the curves, the horizontal and vertical chain links interlock. During use thereof, the chains are exposed not only to the tensile force transmitted, but also to abrasive wear.

A reduction in the cross-sectional area of the legs while maintaining the same cross-sectional area of the curves in order to reduce the dead weight and the dimensions of a link chain is described, for example, in DE 103 48 491 B3. The respective chain link is made into a flat chain link with flattened legs through a forging process.

DE 10 2010 013 475 A1 describes a chain strand which includes individual horizontal links and vertical flat links.

### SUMMARY

The object of the present disclosure is to provide a chain link which is optimized and improved in terms of its own weight and the tensile force to be transmitted.

The aforementioned object is solved in a chain link according to the present disclosure.

A further object of the present disclosure is to provide a manufacturing method with which a chain link with good shaping flexibility and an improved material structure is able to be produced.

This object is achieved according to the present disclosure with a method for producing a chain link.

The chain link according to the present disclosure is part of a link chain, also able to be referred to as a conveyor chain or flat link chain and is used, for example, in mining. The chain link has two legs that run parallel to each other, with the legs being connected to each other at the ends by a respective curve.

The legs and the curve of the chain link are circular in respective cross-sections, with the legs having a smaller cross-sectional area than the cross-sectional areas of the curves.

Due to the reduced cross-sectional area in the legs compared to the curves, the chain link is lighter than a comparable chain link with the same cross-sectional area all around.

The tensile force to be transmitted is not affected by the reduction in cross-section in the legs. This means that the full tensile force able to be transmitted by the cross-sectional area of the curve is available. Due to the lower weight of the link chain, wear and tear during operation of the link chain formed from the chain links is reduced. Due to the smaller cross-sectional areas, in the region of the legs, material expenditure for producing the link chain is able to be saved, which also reduces material costs.

According to the present disclosure, the chain link is produced by radial forging, also referred to as rotary swaging or longitudinal forging. Radial forging is an open-die forging process in which the cross-section of the workpiece is reduced in a deformation region using 3 or 4 opposing dies or punches arranged radially around the longitudinal axis of the workpiece in a plane perpendicular to the longitudinal axis of the workpiece. The workpiece is rotated around its own longitudinal axis between the individual punch strokes. Compared to producing a chain link using a forging process, in which the workpiece is forged between a flat upper die and a flat lower die, radial forging has two major advantages:
the ability to forge low-ductility and difficult-to-deform steels and alloys due to the favorable stress and strain state of the metal in the deformation zone.
prevention of cracks or breaks on the material surface through the radial arrangement of the punches.

Furthermore, the cross-sectional reduction of the chain link semi-finished product produced by radial forging, in the region of the legs, leads to a longitudinal deformation of the chain link semi-finished product in the longitudinal direction of the chain link semi-finished product in the deformation region. This in turn induces a longitudinally directed material structure in the deformation region. The longitudinal material structure increases the load-bearing capacity of the chain links and of the legs in the longitudinal direction of the chain link when the link chain is subjected to a tensile force. In addition, the rotationally symmetrical shape of the formed chain link semi-finished product allows for avoiding errors when inserting the semi-finished product into a bending device.

According to the present disclosure, a circular cross-section of the chain link semi-finished product is produced during production, but the surface of the chain link semi-finished product has minimal irregularities due to the radial forging process. Thus, a chain link produced by radial forging is able to be clearly distinguished from chain links produced in other ways by its material structure and surface finish.

Radial forging is carried out with axial feed of the chain link semi-finished product. Thus, the chain link semi-finished product, which is a profile bar, is moved in its axial direction relative to the dies during the radial forging process. The forging process itself leads to a reduction in the diameter of the chain link semi-finished product, which results in a longitudinal deformation of the chain link semi-finished product in its axial direction. By axially feeding the chain link semi-finished product, length portions, for example, the later legs of the chain link, are able to be formed. Radial forging with axial feed forms a homogeneous and longitudinally oriented material structure in the deformation region of the chain link semi-finished product. In at least one embodiment of the present disclosure, a uniform fiber orientation is formed in the axial direction. The fiber orientation is a structural metallographic property, such as a line-like arrangement of the crystallites of the primary structure or of the contained grain boundaries and inclusions. This structure has proven to be advantageous for the load-bearing capacity of the deformation regions when subjected to a tensile force in the axial direction, since the fiber direction coincides with the main force linear flow in the tensile direction.

If the deformation regions after the chain link semi-finished product has been formed into a chain link are the legs of the chain link, the load-bearing capacity of the legs oriented in the longitudinal direction of the chain is increased when a tensile force acts on the chain link in the longitudinal direction of the chain. The material structure is demonstrably different from the material structure of chain links described in the aforementioned references.

In at least one embodiment of the present disclosure, a transition region from the cross-sectional areas of the legs to the cross-sectional areas of the curves is formed starting at the respective end of the legs. The transition region is also able to be partially located in the region of the legs. In at least one embodiment of the present disclosure, the cross-section of the transition region is circular in its longitudinal direction.

The diameter of the legs is between 5% and 15% or between 9% and 11% smaller than the diameter of the curve. These diameter ratios are advantageous as the longitudinal material structure is induced by radial forging and is formed over the entire cross-section of the legs. With other diameter ratios, the advantageous material is able to, for example, only be formed on the outer edges of the legs. These diameter ratios therefore represent an optimum for the load-bearing capacity of the chain links or legs in the longitudinal direction of the chain link.

Furthermore, when viewed from the side of the central longitudinal axis plane, the inner contour line and the outer contour line of the chain link have a continuous oval shape all the way around. The oval shape has two parallel sides and a semicircular configuration connecting the respective ends of the sides. This oval shape of the inner and outer contour line is not interrupted at any point by a constriction, a bridge, a shoulder, a step shoulder, a slope or the like. The oval design is advantageous for the stress distribution and the force flow within the chain link.

The method according to the present disclosure is used to produce a chain link for a link chain. The chain link has two legs that run parallel to each other and are connected at the ends by curves. The legs and the curves of the chain link are circular in respective cross-sections, with the legs having smaller cross-sectional areas than the cross-sectional areas of the curves. The chain link is manufactured by radial forging with the following steps:
providing a profile bar, wherein the profile bar is made of a steel material,
inserting the profile bar into a radial forging machine and radial forging with reduction of the diameter of the profile bar in longitudinal portions, so that the profile bar is axially stretched in the forged longitudinal portion, wherein the diameter is reduced in the region of the later legs,
axially feeding the profile bar during the radial forging process to form the longitudinal portions of the later legs,
removing the radially forged chain link semi-finished product and forming the semi-finished product into a chain link as well as welding the front ends of the formed chain link.

At least one advantage of the present disclosure is greater freedom of design, since both the cross-sectional areas of the curves to be produced later and the cross-sectional areas of the legs to be produced later are able to be produced individually, i.e., with a high degree of freedom of design. Because no material needs to be removed from the longitudinal portions of the manufactured chain link with a smaller cross-sectional area, the amount of material used to produce each chain link is lower.

The cross-sectional reduction of the chain link semi-finished product leads to a longitudinal deformation of the chain link semi-finished product in the deformation region, which in turn induces a longitudinally directed material structure. As has been shown, this is another advantage of the present disclosure, since the longitudinal structure increases the load-bearing capacity of the chain links and of the legs in the longitudinal direction of the chain link. In addition, the rotationally symmetrical shape of the formed chain link semi-finished product allows for errors to be avoided when inserting the semi-finished product into a bending device.

In radial forging, pressure is repeatedly applied to the workpiece via multiple punches arranged around the axis of a workpiece.

According to the present disclosure, the workpiece is a profile bar made of a steel material. The profile bar has a length that is shorter than the circumferential length of the chain link to be produced later. The profile bar is solid and made of a hardenable steel material. The profile bar has a round cross-section.

This provided profile bar is clamped into the radial forging machine at its both ends or on one side so that the profile bar is able to be rotated by the machine along its central longitudinal axis and moved back and forth in the axial direction. The punches arranged radially around the profile bar then exert pressure on a defined longitudinal portion of the profile bar. The profile bar is then rotated around its own axis and the punches again exert pressure on the profile bar. Thus, the cross-sectional area of the profile bar is reduced in the forged longitudinal portion and the profile bar is axially stretched in the deformation region. This method is repeated until a predefined diameter is reached in the relevant longitudinal portion of the profile bar. According to the present disclosure, at least the cross-sectional area in the region of the later legs is reduced, as is the size in the area of the later curves.

After completion of the radial forging process, a rotationally symmetrical chain link semi-finished product is produced from the profile bar by forming. The length of the chain link semi-finished product corresponds to the circumferential length of the chain link to be produced. The longitudinal portions of the chain link semi-finished product in the region of the later curves as well as the longitudinal portions of the chain link semi-finished product in the region of the later legs of the chain link are circular.

The chain link semi-finished is then removed from the radial forging machine and formed into a chain link. The two front ends are pressed together intermittently and welded during the forming process. For this purpose, laser welding or resistance welding is able to be used. Alternatively, a friction welding process is also able to be carried out.

The longitudinal portions with the smaller cross-sectional areas form the legs of the chain link and the longitudinal portions with larger cross-sectional areas form the curves.

The cross-sectional area of at least one curve corresponds to the cross-sectional area of the profile bar.

In at least one embodiment of the present disclosure, at least one longitudinal portion of a subsequent curve is also able to be reduced in size during radial forging.

The chain link semi-finished product has a transition region between the longitudinal portions of the later curves and legs. This amounts to between 3% and 10% or between 4% and 7% of the total length of the chain link semi-finished product. These conditions are advantageous for the force flow and the stress distribution within the chain link.

Furthermore, the welded front ends of the formed chain link are located in the region of the legs.

In at least one embodiment of the present disclosure, the profile bar is radially forged in a warm or semi-warm state. In at least one embodiment of the present disclosure, the chain link semi-finished product is also able to be formed into the respective chain link in a warm state. In at least one embodiment of the present disclosure, radial forging is able to be carried out in the cold state, or at room temperature.

In at least one embodiment of the present disclosure, the formed and welded chain link is tempered.

### BRIEF DESCRIPTION OF THE DRAWINGS

Further advantages, features, and properties of the present disclosure are the subject matter of the following description. Various embodiments are shown in the figures. These simplify the understanding of the present disclosure.

In the figures:

FIG. 1 shows a part of a link chain with chain links according to an embodiment of the present disclosure in plan view,

FIG. 2 shows a chain link according to an embodiment of the present disclosure in plan view;

FIG. 3 shows a sectional view through a chain link according to an embodiment of the present disclosure according to section line A-A of FIG. 2,

FIG. 4 shows a sectional view through a chain link according to an embodiment of the present disclosure according to section line B-B of FIG. 2,

FIG. 5 shows a side view of a profile bar according to an embodiment of the present disclosure,

FIG. 6 shows a side view of a chain link semi-finished product according to an embodiment of the present disclosure,

FIG. 7 shows a side view of a radial forging machine with clamped profile bar according to an embodiment of the present disclosure,

FIG. 8 shows a sectional view of the radial forging machine according to section line C-C in FIG. 7 according to an embodiment of the present disclosure, and

FIG. 9 shows a sectional view according to an embodiment of the present disclosure of the radial forging machine.

### DETAILED DESCRIPTION

In the figures, the same reference numerals are used for same or similar objects, even if a repeated description is omitted for reasons of simplicity.

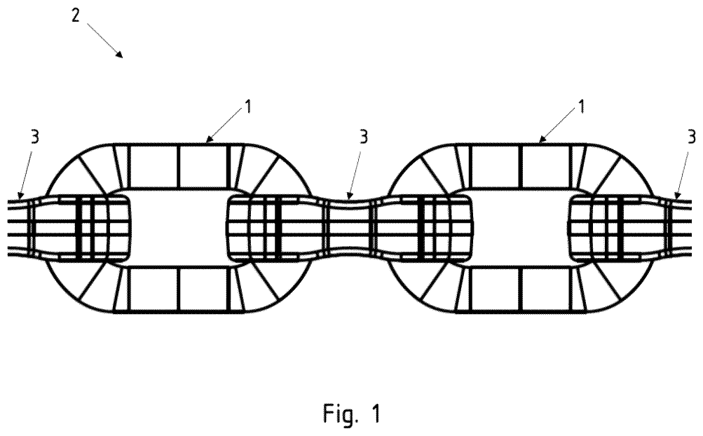

FIG. 1 shows a chain link 1 according to the present disclosure in plan view, as part of a section of a link chain 2. The chain links 1 are designed here as horizontal links. The vertical links 3 connect the chain links 1, wherein the vertical links 3 are manufactured elsewhere. Not shown in more detail, further chain links 1 in the form of horizontal links, followed by a further vertical link 3 and following, are arranged on the right and left of the image plane.

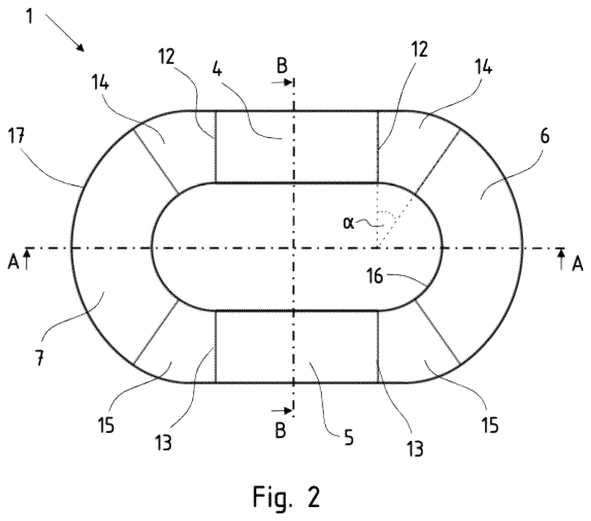

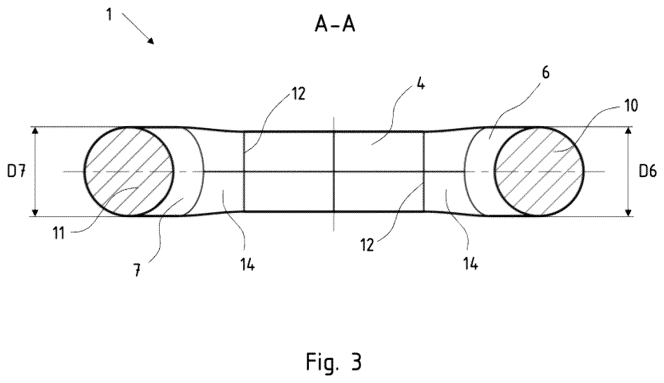

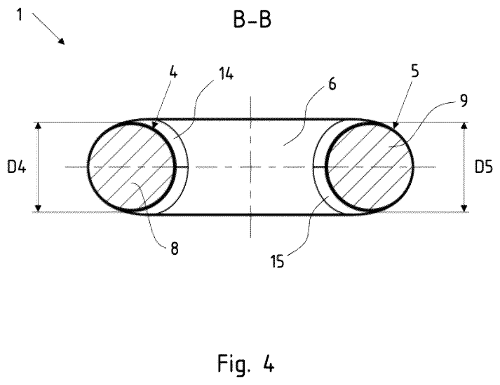

FIG. 2 shows the detailed view of a chain link 1 according to the present disclosure in plan view. The chain link 1 has two legs 4, 5 that run parallel to each other and are connected at the ends by curves 6, 7. The legs 4, 5 have cross-sectional areas 8, 9, each of which is circular, see FIG. 4. The curves 6, 7 also have cross-sectional areas 10, 11, each of which is also circular, see FIG. 3. The cross-sectional areas 8, 9 of the legs 4, 5 are smaller than the cross-sectional areas 10, 11 of the curves 6, 7. At the respective end 12, 13 of the legs 4, 5, a transition region 14, 15 extends towards the curves 6, 7. The transition regions 14, 15 are also circular in shape. The transition regions 14, 15 extend from the respective end 12, 13 of the legs 4, 5 at an angle α of greater than 0 degrees to an angle of less than 45 degrees, so that the legs 4, 5 then merge into the curves 6, 7.

The inner contour line 16 and the outer contour line 17 of the chain link 1 have a continuous oval shape. This oval shape of the inner and outer contour line is not interrupted at any point by a constriction, a bridge, a shoulder, a step shoulder, a slope or the like.

The diameters D4, D5 of the legs 4, 5 shown in FIG. 4 are between 4 mm and 6 mm smaller than the diameters D6, D7 of the curves 6, 7 shown in FIG. 3. Furthermore, the diameters D4, D5 of the legs 4, 5 are between 9% and 11% smaller than the diameters D6, D7 of the curves 6, 7.

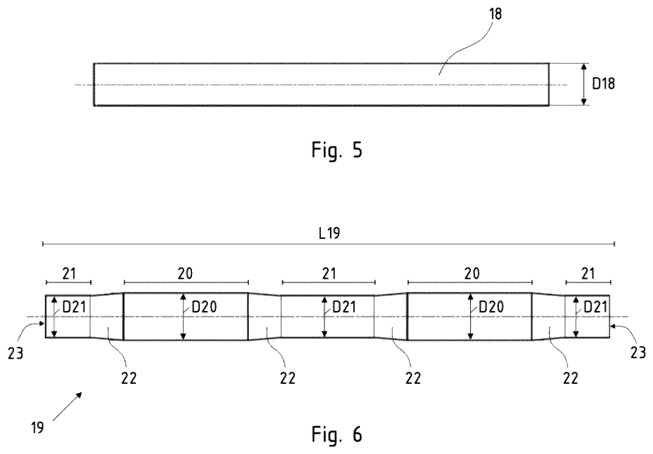

FIG. 5 shows a profile bar 18 which is circular and rotationally symmetrical, with the diameter D18.

FIG. 6 shows a chain link semi-finished product 19, which was made from the radially forged profile bar 18. The chain link semi-finished product 19 has two longitudinal portions 20, the diameter D20 of which corresponds to the diameter D18 of the profile bar 18, but is also able to be smaller. The longitudinal portions 20 form the region of the later curves 6, 7 of the chain link 1. Thus, the diameter D20 of the longitudinal portions 20 corresponds to the diameter D6, D7 of the curves 6, 7.

Furthermore, the chain link semi-finished product 19 has the longitudinal portions 21 which correspond to the regions of the later legs 4, 5. Thus, the diameters D21 of the longitudinal portions 21 are equal to the diameters D4, D5 of the legs 4, 5.

A transition region 22 is arranged between the longitudinal portions 20 and 21. This corresponds approximately to the later transition regions 14, 15 of chain link 1.

The chain link semi-finished product 19 is connected at its front ends 23 to form the chain link 1.

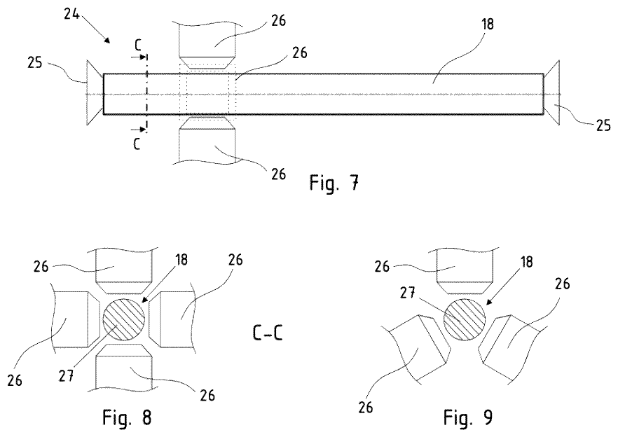

FIG. 7 shows a simplified representation of a radial forging machine 24 in which the profile bar 18 is arranged. The profile bar 18 is clamped at both its ends via clamps 25 in the radial forging machine 24. The profile bar 18 is able to be rotated about its longitudinal axis and also moved back and forth in the axial direction via the clamps 25. Opposite punches 26 are arranged radially around the profile bar 18. This is able to be seen in FIG. 8. The punches 26 apply pressure to the profile bar 18 so that is the profile bar 18 is stretched in its axial direction. The cross-sectional area 27 of the profile bar 18 is thus reduced in the region worked by the punches 26. By axially displacing the profile bar 18 in the left and right directions relative to the image plane of FIG. 7, the entire profile bar 18 is able to be reached and forged by the punches 26.

FIG. 9 shows an embodiment of the radial forging machine 24 with 3 punches 26.

The foregoing description of some embodiments of the disclosure has been presented for purposes of illustration and description. The description is not intended to be exhaustive or to limit the disclosure to the precise form disclosed, and modifications and variations are possible in light of the above teachings. The specifically described embodiments explain the principles and practical applications to enable one ordinarily skilled in the art to utilize various embodiments and with various modifications as are suited to the particular use contemplated. Various changes, substitutions and alterations can be made hereto without departing from the spirit and scope of the disclosure.

1. A chain link for a link chain, wherein
the chain link has two legs running parallel to one another,
the two legs are connected to one another at respective ends via curves,
the legs and the curves of the chain link are circular in respective cross sections,
the legs have smaller cross-sectional areas compared to cross-sectional areas of the curves,
the chain link is produced by radial forging, and
a diameter of the legs is between 5% and 15% smaller than a diameter of the curves.

2. The chain link according to claim 1, wherein a transition region from the cross-sectional areas of the legs to the cross-sectional areas of the curves begins at the respective end of the legs.

3. The chain link according to claim 2, wherein a cross-section of the transition region has a circular longitudinal extension.

4. The chain link according to claim 1, wherein the diameter of the legs is between 9% and 11% smaller than the diameter of the curves.

5. The chain link according to claim 1, wherein, in a side view of a central longitudinal axis plane, an inner contour line and an outer contour line of the chain link have a continuous oval shape all the way around.

6. The chain link according to claim 1, wherein the radial forging takes place with axial feed.

7. A method of producing a chain link according to claim 1, comprising:
providing a profile bar, wherein the profile bar is made of a steel material,
inserting the profile bar into a radial forging machine and performing radial forging with reduction of a diameter of the profile bar in longitudinal portions, so that the profile bar is axially stretched in the forged longitudinal portions, wherein the diameter is reduced at least in a region of the later legs, wherein a transition region between the longitudinal portions of the later curves and legs of a chain link semi-finished product accounts for between 3% and 10% of a total length of the chain link semi-finished product, and
removing the radially forged chain link semi-finished product and forming the chain link semi-finished product into a chain link as well as welding front ends of the formed chain link.

8. The method according to claim 7, wherein the diameter of the profile bar corresponds to the diameter of at least one of the curves.

9. The method according to claim 7, wherein the diameter of at least one longitudinal portion of a later leg is reduced during the radial forging.

10. The method according to claim 7, wherein the transition region between the longitudinal portions of the later curves and legs of the chain link semi-finished product accounts for between 4% and 7% of the total length of the chain link semi-finished product.

11. The method according to claim 7, wherein the welded front ends of the formed chain link are located in the region of the legs.

12. The method according to claim 7, wherein the profile bar is radially forged in a cold, warm or semi-warm state.

13. The method according to claim 7, wherein the formed and welded chain link is tempered.
